(19) United States
(12) Patent Application Publication
(10) Pub. No.: US 2005/0274246 A1
(43) Pub. Date: Dec. 15, 2005

(54) On-grill portioning tool and method

(76) Inventor: Thomas L. Lovewell, Hays, KS (US)

Correspondence Address: SHOOK, HARDY & BACON LLP, 2555 GRAND BLVD, KANSAS CITY,, MO, 64108, US

(21) Appl. No.: 10/865,313

(22) Filed: Jun. 10, 2004

(51) Int. Cl. B26D 7/01

(52) U.S. Cl. 83/451; 83/932

(57) ABSTRACT

Disclosed is a device for portioning food-items. The device may be used on a grill as part of an on-grill cutting process. The device includes a handle, a cross bar, and two forwardly extending members. In use, a steak is slid in between the two forwardly extending members of the device until it abuts the cross member. Then, the user uses a knife to cut off the portion which is included between the cross bar and two forwardly extending portions. This is by placing the blade of the knife at the ends of the forwardly extending members to make the cut. The device ensures that each steak cut is the same size.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field of the Invention

Broadly speaking, the present invention is a portioning device for cutting food items into properly sized portions in a restaurant. More specifically, the present invention is a device and method of receiving a food item in a device which includes a knife guiding system which guides the knife in such a manner a properly sized portion is cut from the food item for a customer.

2. Description of the Related Art

One of the most common prior-art ways to portion smaller food items off from a larger food item is to make a visual estimation of the desired size, and then cut off a best-guess assessment of the desired portion with a knife. This technique works well-enough in circumstances in which it is unimportant that each of the pieces cut from the food item have specific size or weight requirements. When maintaining specific sizes and weights of portions, however, this conventional technique fails. This is because the accuracy and the sizes of the portions is only as good as the cutter's best efforts.

Using grilled steaks served at a residential barbeque as an example, the preparer may be slicing a large grilled sirloin steak for four persons. Because this preparer has no way to really ensure that each of the four pieces will be cut the same size, it is inevitable that some of the guests will get larger portions than others. This may cause some waste. In casual settings like this, however, accurate portioning is not much of an issue. This is because, though guests may be disappointed if they receive a portion a couple of ounces smaller than that of someone else, there is no real financial penalty to anyone.

The situation is much different in business settings. Waste caused by improper portioning of food items in restaurants has major costs. For restaurants which serve steaks, for example, the cost of steak meat is one of the main expenses of the business. For steakhouses, the cost of steak is oftentimes the greatest single source of overhead cost. Because it is so expensive, and because the quantity prepared by the typical steakhouse is tremendous, the repeated waste of ounces of steak caused by improper portioning will quickly add up. Thus, repeated waste caused by the chefs inaccurate portion estimations will cost the restaurant significant profits.

Traditionally, businesses have managed this problem by simply precutting the steaks to specific sizes before delivering them to the restaurant. The steaks were then prepared on a grill in the kitchen out of the view of the customers. Behind the scenes, if you will. This technique proved to be fairly efficient in terms of avoiding waste. Recently, however, this pre-portioning behind-the-scenes approach has lost favor with the consumer.

Consumers have flocked to restaurants which prepare food in front of the customer. Japanese-style steakhouses and Mongolian-style barbeques are two of numerous examples of this phenomena. At these restaurants, the food items are grilled directly in front of the customer. There is no pre-slicing or pre-packaging of individual portions of meat. The portioning, instead, is done right in front of the consumer. The preparer uses the conventional method of making a visual estimation of the desired portion size, and then cuts off a best-guess assessment of the desired portion with a knife.

Because the prep takes place before the consumer's eyes, the consumer is able to actually select the food-item they want. Even the portion of the food item. Plus, they have the satisfaction of watching the preparer at work. Consumers often find this to be entertaining. Additionally, they are able to interface with the cook with respect to desired particulars regarding the food item. E.g., whether it is cooked to the extent desired, seasoned to their taste, etc.

Taking advantage of the consumer's enthusiasm for these conventional viewable-prep restaurants, traditional steakhouses have recently gotten in on the action. Discarding (partially) the age-old proportioning methods, many steak-serving restaurants have resorted to a new technique.

This new technique is called on-grill cutting of steaks. It is accomplished by moving the grills (either griddles or char-grills) from the kitchen to a place in the restaurant that it is visible to customers. Typically there is a clear Plexiglas or other kind of transparent protective panel place in front of the grill to avoid splattering customers and also avoiding customers touching the grill and burning themselves.

The grill, or grills, may also be placed in a sort of buffet setting. In such a setting, the consumer will get steak from one part of the buffet and other food items from other parts of the buffet. At the grill, the consumer is able to pick out the specific meat that he or she desires. After the particular food item has been selected, the chef will then prepare the steak.

Normally, the consumer will only be given a portion of the large steak that is prepared in front of them. In order to mete out portions, the chef has to guess at the particular size and cut off a portion by sizing it visually. Much like the traditional approach described in the opening paragraph in this section.

This new approach of on-grill cutting has created severe profitability problems for restaurants. This is because the cost of the meat is so great. Also because the individuals doing the preparing of the steaks (chefs, fry cooks, others) may not be skilled enough to prevent providing the customer with a much larger portion than intended. Studies have also shown that preparers tend to err on the side of being too generous, rather than too stingy. Thus, the preparer will typically cut off a larger portion than necessary. For example, if the customer is only supposed to get a ten ounce portion of a sirloin, and the preparer accidentally cuts twelve ounces of meat, the business has essentially given away two ounces for no reason. The consumer may not even desire such a large quantity. The repeat of this error as a matter of routine will result in tremendous waste.

The flip-side to the possibility of overages to the consumer is even worse. It is also possible, of course, that the preparer would portions too small. Repeated errors of this kind could have disastrous consequences. A reputation in the consumer community of under proportioning will turn away customers in droves.

Despite these potential pitfalls, the popularity of the consumer viewable on-grill steak buffet continues to soar. Consumers have driven this popularity based on their preference that they be able to see the fresh meat before selecting a particular steak. Additionally, there is an entertaining quality to it. The consumers simply like watching the chef cooking their meal in front of them. Further, granted the chef has a high level of skill, it give the restaurant an opportunity to wow the consumer with its competency and food preparation. Because of this, many steak houses have stuck with the consumer-viewable technique, requiring on-grill cutting despite the portioning problems involved.

Because of the potential waste and/or other harm caused by these consumer-viewed grilling techniques, there is a need in the art for a device and method which enables on-grill cutting with accurate portioning. The restaurant conducting a visible grill station as part of a buffet or other food presentation must be able to properly portion the steaks cut while cutting them on the grill.

### SUMMARY OF THE INVENTION

The device and method of the present invention overcome these prior art disadvantages and enable the restaurant to maintain profitability while still enjoying the consumer-attraction value of an on-grill cutting presentation to the customer. This is done by providing a food-item portioning device. This device portions a food-item. The food item portioned will have first and second edges.

With respect to the device, it will have a body. First and second members will extend forwardly from the body, thus defining a receiving area. This is the area in which the food item is to be received before cutting. The first forwardly extending member is adapted to abut the first edge of the food item. The second forwardly extending member is adapted to abut the second side of the food-item.

Each of the first and second forwardly extending members have ends. These ends are used to guide a knife in order to create a cut line in the food item. When the knife is used to slice the meat on this cut line, the portion will be severed from the food-item and is ready to be served to a consumer. The portion of steak cut will conform to the receiving area defined by the first and second forwardly extending members. The lengths of the first and second forwardly extending members may be changed to create different sized portions. They may also be moved further apart or closer together to accommodate different sizes. This is done by placing them at different portions on a cross member which is part of the body.

In one embodiment the cross bar extends laterally and the first and second forwardly extending members extend out at ninety degree angles to the cross bar.

Many different embodiments of the present invention are also possible. For example, it would be possible to manufacture a portioning device which would function adequately, however, would only have one forwardly extending arm on its cross member. Many variations are also possible regarding the ends of the forwardly extending members. The knife guides on these ends could be, as disclosed in the embodiments illustrated in this application, the outside surfaces on the ends of these members. Alternatively, slots could be created in only one end which would direct the knife at a particular angle (e.g., normal to the forwardly extending member, or at some other angle).

### BRIEF DESCRIPTION OF THE SEVERAL VIEWS OF THE DRAWINGS

The present invention is described in detail below with reference to the attached drawing figures, wherein:

FIG. 1 is a perspective view of the device of the present invention viewing it from its back side.

FIG. 2 is an illustration of the device of the present invention showing it from its forward end.

FIG. 3 shows the device of the present invention in use on a grill being used by a preparer to portion a steak for a consumer.

### DETAILED DESCRIPTION OF THE INVENTION

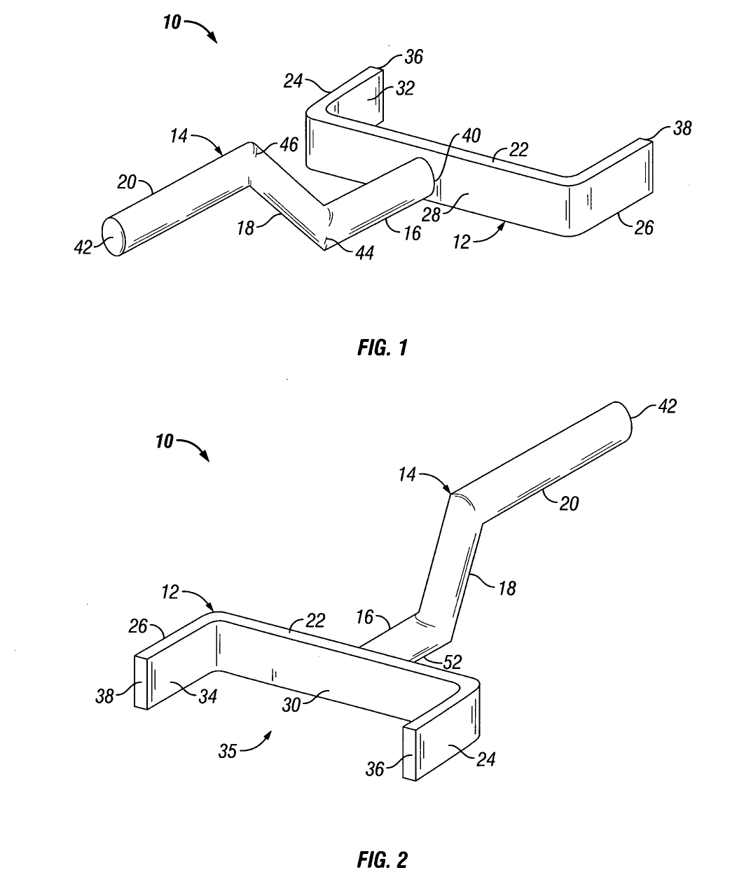

The preferred embodiment of the present invention is shown disclosed in FIGS. 1-3. This device shown has proven to result in much greater profits for the restaurant or other business using it. With respect to steak houses, the device has proven to turn around the profitability problems existing in the prior art. This is done because the device enables the user to properly size portions of a particular food item. This may be done while the business presents the consumer with a cut-on-the-grill viewing station. Consumers are able to view the particular food item they desire, because the grill is open to viewing by consumers.

The tool disclosed is a device for portioning food-items. It may be used on a grill as part of an on-grill cutting process. The preferred embodiment of the device includes a handle, a cross bar, and two forwardly extending members. In use, a steak is slid in between the two forwardly extending members of the device until it abuts the cross member. Then, the user uses a knife to cut off the portion which is included between the cross bar and two forwardly extending portions. This is by placing the blade of the knife at the ends of the forwardly extending members to make the cut. The device ensures that each steak cut is the same size. This enables the chef to cut off appropriately sized portions without taking away from the ambiance created by the customer-viewed grilling process.

Referring to FIGS. 1 and 2, we see that the device of the present invention is an on-grill cutting tool 10. The tool 10 has two sections—a portioner 12 at one end, and a handle 14 at the other.

Handle 14 has a horizontally extending portion 16. Horizontally extending portion 16 is welded or otherwise fixed to portioner 12. Behind horizontally extending portion 16 is an upwardly angled portion 18. Upwardly angled portion 18 is angled upward to meet up with a grip portion 20. Grip portion 20 is what the user will hold in order to use the device.

Because the handle is angled upward from the portioner when the portioner is on a substantially planar surface (such as a grill), the grip may be safely handled by the preparer without the risk of burning himself or herself. Additionally, the handle is configured in such a way that it may be positioned completely off the grill. Because it is not over the grill's surface, it will not heat up while the cutting is going on.

Portioner 12 comprises several components. Handle 14 is fixed to a cross member 22 on said portioner. Cross member 22 extends horizontally outward from the handle and is perpendicular to it. On one side of cross member 22 is a first forwardly extending member 24. On the opposite side of cross member 22 is a second forwardly extending member 26. Cross member 22 has an outside surface 28 and in inside surface 30. Similarly, first forwardly extending member 24 has an inside surface 32. Second forwardly extending member 26 also has an inside surface 34. Inside surfaces 30, 32 and 34 together define a food-item receiving area 35. Receiving area 35 is where the food-item is received before cutting.

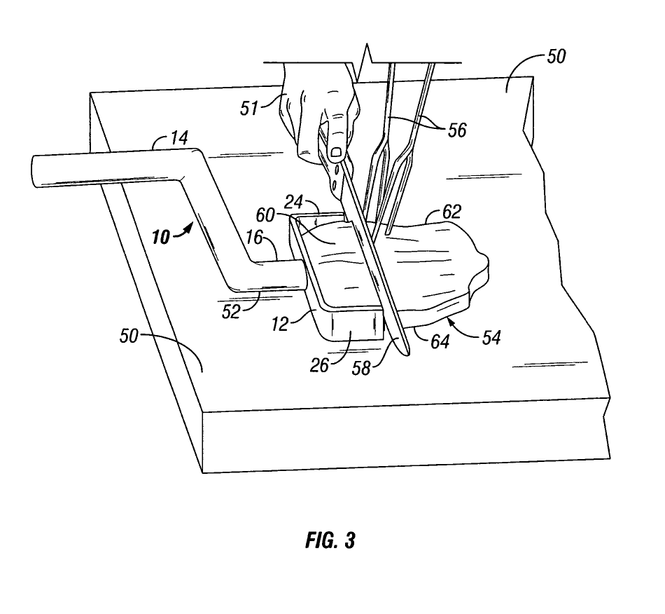

The ends of extending members 24 and 26 are used to guide a knife 58 (see FIG. 3). The first forwardly extending member 24 includes a knife-engaging surface 36. The second forwardly extending member 26 also includes a knife-engaging surface 38. Most food items will have lengths and widths which are not equal. In the case of a typical food item, it will be longitudinally slid into the receiving area (see FIG. 3) for cutting. In order to insure a true cut, the item should be pressed into the receiving area such that all of surfaces 30, 32, and 34 are contacted. Receiving area 35 defines the portion specifications desired.

A knife 58 is then used to cut off the portion. This is done by engaging the blade of the knife with end surfaces 36 and 38 to define a cut line (not pictured). Slicing the food item along this cut line will create severance of a portion from the remainder of the food-item. The portion will be of the desired specifications defined by the receiving area. Once cut, the portion may be served to a consumer.

Referring now to FIG. 3 we see the device of the present invention 10 being used on a grill 50 for cutting a steak on the grill in a customer viewing area. Referring to the figure, we see a user 51 cutting a food-item 54. In this figure, food-item 54 is a sirloin steak. Sirloin steaks, like numerous other steaks, and other food items has edges. A first edge exists on a first side 62 of the steak. A second edge exists on a second side 64 of the steak.

You will note that the term “side” has, and will later be, used in reference to the food item throughout this application. This term is not intended to be limited to any particular shape or location on the food item. It instead, as its plain meaning would suggest, implies only a surface bounding the item. This surface may have any location or shape. When different sides, e.g., first and second sides, are referred to, this means simply two sides on the item having any location or shape. No other, more narrow, meaning is intended.

With the process of the present invention, the user will typically place steak 54 on grill 50 and cook it for a period of time (on both sides). When the steak 54 is done or near to done, the user will place one end of steak 54 in the receiving area 35 defined by the portioner 12. When this occurs, first side 62 of the steak will contact and press against inside surface 32 of the first extended member 24 and second side 64 of the steak will contact and press against inside surface 34 of the second extended member. The end of the steak to be cut will be pressed against the inside surface 30 of the cross bar.

It will also be seen in the figure that, when in use, the bottom 52 of horizontally extending portion 16 rests squarely on the grill surface 50. This prevents the weight of handle 14 from tipping device 10 backward. It also frees the preparer's hands. When this is done, the user may use tongs 56 or some other kind of device to secure the steak in position while cutting. A portion 60 of steak 54 will be sized by the proportioner 12.

The user will then use a knife 58 to make the cut. Once the cut is made, properly sized portion 60 will be severed from the rest of the steak 54. This sized portion 60 will then be served to the consumer without any waste. This is because the receiving area 35 in portioner 12 has been sized (by way of the cross member 22 and first and second forwardly extending members (24 and 26) to consist of a particular size and weight desired by the restaurant, or other controlling entity.

Once portion 60 has been removed and served, the remainder of steak 54 may be moved into portioner 12 in order to make another cut. This process may continue until steak 54 is used up.

The preferred embodiment of the present invention is manufactured by known metal working techniques. The handle is fixed to the outside surface 28 of cross bar 22 of the portioner 12. This is done by a weld 40 which fixes the horizontally extending portion 16 to outside surface 28 of cross member 22. The other end of handle 14 is a free and unconnected end 42. The horizontally extending portion 16 is attached to the upwardly angled portion 18 at an upward bend 44. This upward bend 44 may be formed by welding the two portions (16 and 18) together. It also may be formed by bending. After angling upward, handle 14 again levels off at the grip portion 20. This leveling off is done by way of a leveling bend 46 between upwardly angled portion 18 and grip portion 20. Again, like with upward bend 44, leveling bend 46 is created by welding, bending, or some other known technique.

In the preferred embodiment, all of device 10 comprises stainless steel. Stainless steel has been chosen because of its superb durability. It also can withstand high temperatures. Furthermore, it is able to be washed, exposed to the cooking processing, and other harsh environments without degrading (e.g., rusting). Other materials of course could be used which would accomplish the objectives of the present invention. For example, iron, aluminum, or other metals could be used to accomplish the objectives. Further, a combination of materials could be used. For example, the handle could be wooden while the portioner is metal. The grip portion 20 could include a grip-enhancing covering. It is not the intent that the material used to make up device 10 is in any way limiting. The use of other known materials will be well within the knowledge of one skilled in the art.

Other variations or embodiments of the present invention are also possible, and are included within the scope of the present invention. For example, though the present invention shows the use of two forwardly extending members, the objectives of the present invention could also be accomplished by creating a device with only one forwardly-extending member. Though possibly not as easily used as the two-member design of the preferred embodiment disclosed in FIGS. 1-3, a one pronged embodiment would have a knife guiding device on its extending member. This device might include a slot or other guiding means which would direct the knife at a particular angle. Possibly normal to the handle and cross bar as is shown with the device 10. Alternatively, this one pronged embodiment could direct the blade at an angle for an angled cut.

Another variation considered by applicant to be part of the present invention is the concept that the forwardly extending members 24 and 26 could be varied in length. This would create an angled cut. Angled cuts may be desired for different purposes.

It is also of course possible that the cross bar 22 and extending members 24 and 26 could be proportioned differently such that the cross bar is shorter in length than each of the extending members 24 and 26. This might be desirable when cutting especially long types of meats. None of the sizes or proportions involved should be considered a limitation of the present invention and are to be considered within the scope of the present invention.

It is also possible that an embodiment of the present invention would not include a cross bar at all. With this forked-member embodiment, the forwardly extending members would extend from a common portion, but that portion would not be in the shape of a crossbar. Such a device might have a wishbone-shaped receiving area. The wishbone-shaped receiving area would be formed by branching (or forking) the first and second members away from a common point. This would mean that the inside surfaces of curved first and second extending members alone would define the size of the portion. When inserted into the receiving area, the steak would simply press against the inside surfaces of the forked first and second forwardly extending members. There would be no necessity for a cross member.

Thus, there has been shown and described a device and method for proportioning food items on a grill or other surface. Many changes, modifications, variations, and other uses and applications of the subject invention will, however, become apparent to those skilled in the art after considering this specification together with the accompanying figures and claims.

1. A food-item portioning device for portioning a food item, comprising:
a body having first and second forwardly extending members defining a receiving area for receiving a portion of said food item;
said first forwardly extending member adapted to abut a first side of said food item;
said second forwardly extending member adapted to abut a second side of said food item; and
each of said first and second forwardly extending members having knife-guiding ends which act together to create a cut line for a blade to cut said portion from said food item.

2. The device of claim 1 comprising:
a cross member for further defining said receiving area by abutting an end of said food item including said portion.

3. The device of claim 1 in which said device is comprised of stainless steel.

4. The device of claim 1 including a grippable handle.

5. The device of claim 4 wherein said device is placed on a level cooking surface, said handle is elevated above said surface.

6. The device of claim 5 wherein said handle is configured such that the proportioner may be controlled from an area not directly above said cooking surface.

7. A food-item portioning device for portioning a food item, said food item having a portion, said portion having first and second sides, said device comprising:
a body having a first forwardly extending member
a cross member;
said first forwardly extending member and said cross member together defining a receiving area for receiving said portion of said food item;
said first forwardly extending member adapted to abut said first side of said portion of said food item;
said cross member adapted to abut an end of said food item; and
an end on said first forwardly extending member having a knife-guiding end which is adapted to create a cut line for a blade, said cut line defining the place in which said portion is severed from said food item.

8. A method of cutting portions of food-items on a grill, comprising:
providing a portioning device having at least one forwardly extending arm for portioning a food item, said food item having a portion, said portion having first and second sides;
receiving an end and at least one of said first and second sides of said food item in said portioning device; and
cutting off said portion from said food item with a knife guided using an end of said at least one forwardly extending arm.
